(19) United States
(12) Patent Application Publication
(10) Pub. No.: US 2024/0024198 A1
(43) Pub. Date: Jan. 25, 2024

(54) Vial Adapter

(71) Applicant: Ferrosan Medical Devices A/S, Søborg (DK)

(72) Inventors: Peter Lund Hammershøj, Brønshøj (DK); Henning Uzoma Igwebuike, Lynge (DK); Tommy Lennart Persson, Hillerød (DK); Torben Ruby, Rødovre (DK)

(21) Appl. No.: 18/248,928

(22) PCT Filed: Nov. 29, 2021
(86) PCT No.: PCT/EP2021/083281

§ 371 Date: Apr. 13, 2023

(30) Foreign Application Priority Data
Nov. 27, 2020 (EP) 20210191.1

(51) Int. Cl. A61J 1/20

(52) U.S. Cl. CPC A61J 1/2055; A61J 1/202; A61J 1/201

(57) ABSTRACT

3.2

FIG. 7

The invention regards a vial adapter, comprising two chamber parts in axial extension of each other, wherein the first chamber part is con- figured for slidably receiving at least a part of the vial crown, and the second chamber part is configured for slidably receiving at least a part of the vial body, wherein the first chamber part andor the second chamber part comprises one

### TECHNICAL FIELD

The present invention relates to a vial adapter.

### BACKGROUND

Bioactive agents are typically stored in medicinal vials, which are vials closed by a vial stopper or cap comprising a pierceable rubber stopper or a septum. The cap may be detachably attached to the vial, e.g. resealable sealed to the vial, and often the cap forms a radially outwardly extending flange from the vial neck and body as illustrated in FIG. 1.

Since bioactive agents are expensive and drug waste undesirable, the bioactive agents are typically stored in the vials in a solid andor dried state, which may improve the 15 chemical stability and facilitate longer storage times. Medicinal vials therefore typically contain powdered drugs andor lyophilized drugs or bioactive agents.

Prior to administration, for example application by injection, the solid bioactive agent may be reconstituted by mixing with a liquid, such that the bioactive agent is easily retrievable from the vial, e.g. by syringe. Hence, liquid transfer between vial and syringe is needed for both reconstitution and drug aspiration.

To ensure rapid and safe liquid transfer to and from the vial, a vial adapter may be used. A vial adapter is a liquid transfer device having a piercing member for piercing or puncturing the septum of the cap, and a fluid transfer port in fluid communication with the piercing member, such that the vial interior is accessible via the fluid transfer port. The vial adapter is attached to the vial prior to liquid transfer.

A vial adapter further typically comprises a cylindrical chamber or skirt concentrically surrounding the piercing member, and thereby shielding the piercing member. The attachment of the vial adapter involves slidingly receiving the vial cap within the cylindrical chamber. Furthermore, the cylindrical chamber may include fastening means for fixing the vial adapter to the cap. For example, WO 99/27886 [1] discloses a vial adapter comprising a cylindrical skirt with radially, inwardly tapering resilient protrusions or tabs for connection to the vial, and standing ribs to assist aligning the vial during insertion.

### SUMMARY

The present disclosure provides a vial adapter with a faster, simpler, more fail-safe, and more flexible fastening of the vial adapter to a vial.

This is obtained by reducing the possible angle of receiving the vial cap within the vial adapter skirt. Particularly it is achieved by means of a vial adapter, comprising two chamber parts in axial extension of each other, wherein the first chamber part is configured for slidably receiving at least a part of the vial crown, and the second chamber part is configured for slidably receiving at least a part of the vial body, wherein the first chamber part andor the second chamber part comprises one or more ribs extending radially inwardly of the chamber wall. Preferably, the first chamber part is configured for slidably receiving at least a part of the vial crown, and the second chamber part is configured for slidably receiving at least a part of the vial body, wherein the first chamber part comprises one or more ribs extending radially inwardly of the first chamber wall. Optionally, the second chamber part is configured for slidably receiving and expanding with a compressive force in response to at least a part of the vial body.

In a preferred embodiment, the first and second chamber parts comprise or consist of coherent cylindrical chamber walls.

In a further preferred embodiment, the one or more radially inwardly ribs are axially oriented ribs. In a further preferred embodiment, the axially oriented ribs are configured as vial crown retainers or wedges, and optionally configured to be elastically compressive outwardly towards the chamber wall.

In another or further embodiment, the one or more radially inwardly ribs are circumferentially oriented ribs, preferably adjacent to a slit, such as a partially circumferentially oriented and partially axially oriented slit. In a further preferred embodiment, the circumferentially oriented rib is configured as a vial crown retainer, and optionally configured for snap fitting over the vial crown.

In another or further embodiment, the piercing member of the vial adapter comprises a cylindrical section and a conic shaped tip section.

### DESCRIPTION OF DRAWINGS

The invention will in the following be described in greater detail with reference to the accompanying drawings.

FIG. 1 shows embodiments of a vial adapter (A), and a vial adapter according to the present disclosure (B), where the possible angle of receiving the vial cap within the vial adapter skirt is indicated by a pie chart.

FIG. 2 shows a 3D cross-section of a vial adapter according to the present disclosure, comprising axially oriented ribs.

FIG. 3 shows a profile view (A) and a cross-section (B) of a vial adapter according to the present disclosure, comprising axially oriented ribs.

FIG. 4 shows a profile view (A) and a cross-section (B) of a vial adapter according to the present disclosure, comprising axially oriented ribs, where the vial adapter is fixed to a vial.

FIG. 5 shows a profile view of embodiments of a vial adapter according to the present disclosure, comprising circumferentially oriented ribs, where (A) and (B) shows perspective views, and (C) and (D) the corresponding line drawings.

FIG. 6 shows a profile view of embodiments of a vial adapter according to the present disclosure, comprising circumferentially oriented ribs, where the vial adapter is fixed to a vial, where (A) and (B) shows perspective views, and (C) and (D) the corresponding line drawings.

FIG. 7 shows a cross-sectional view of a vial adapter according to the present disclosure, comprising circumferentially oriented ribs, when the vial adapter is fixed to a vial. Perspective views are shown to the left, and the corresponding line drawings to the right.

FIG. 8 shows a perspective view of an embodiment of a vial adapter according to the present disclosure, as seen from a bottom perspective.

FIG. 9 shows a cross-sectional view of an embodiment of a vial adapter according to the present disclosure, as seen from a bottom perspective.

FIG. 10 shows a cross-sectional view of an embodiment of a vial adapter according to the present disclosure, where exemplary dimensions are indicated.

FIG. 11 shows a cross-sectional perspective view of an embodiment of vial adapter according to the present disclosure, where exemplary dimensions are indicated.

FIG. 12 shows a cross-sectional perspective view of an embodiment of vial adapter according to the present disclosure, where exemplary dimensions are indicated.

FIG. 13 shows a perspective view of an embodiment of a vial adapter according to the present disclosure, as seen from a bottom perspective.

FIG. 14 shows a perspective view of an embodiment of the piercing member of a vial adapter according to the present disclosure.

### DETAILED DESCRIPTION

The invention is described below with the help of the accompanying figures. It would be appreciated by the people skilled in the art that the same feature or component of the device are referred with the same reference numeral in different figures. A list of the reference numbers can be found at the end of the detailed description section.

### CHAMBER FOR RECEIVING THE VIAL

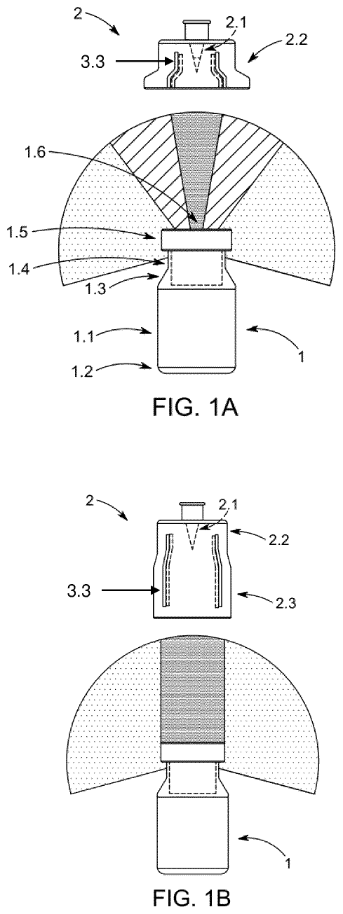

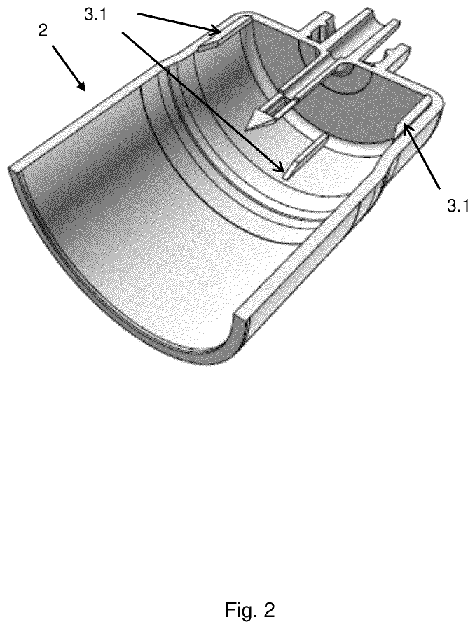

FIG. 1 shows embodiments of a vial adapter 2 for a vial 1, where the vial adapters comprise a longitudinal piercing member 2.1 defining an axial orientation, and a concentrically surrounding chamber or skirt 2.2, configured for receiving the vial cap 1.5, when mounting or attaching the vial adapter to the vial prior to liquid transfer. The chamber or skirt is defined by the concentric chamber walls and a top wall or ceiling, transverse to the axial orientation, and located near a proximal end of the adapter, and opposite to the chamber opening located at a distal end of the adapter.

The vial cap, also known as the vial crown, -stopper, -flange, -collar, or -finish, is thus penetrated by the piercing member of the vial adapter upon attachment of the vial adapter. Specifically the piercing member penetrates the horizontally oriented upper surface of the vial crown, which may comprise a more easily pierceable septum 1.6. The piercing member 2.1 is also referred to as a piercing element, and comprises a hollow spike, e.g. as a part of a cannula, such that is may act as a fluid transfer port. By the term cannula is meant a tube, which concludes with a spikeangular open end to provide fluid access through the entire cannula.

It was found particularly advantageous that the chamber portion of the vial adapter 2 is configured for receiving a further upper portion of the vial. Thus, in addition to receiving the vial crown, the chamber portion is advantageously further configured for receiving the vial neck 1.4, the vial shoulder 1.3, and at least a portion of the vial body 1.1 as illustrated in FIG. 1B. For example, advantageously the length of the vial adapter chamber may be configured for receiving the entire vial body, including the vial bottom 1.2.

From FIG. 1 it follows that when the chamber is configured for receiving a further upper portion of the vial body, then the larger the portion of the vial body received, the lower the risk of incomplete attachment and misalignment. Correspondingly, the longer the vial adapter chamber in the axial chamber direction, or the direction of the 10 longitudinal piercing member, the lower the risk of incomplete attachment and misaligment of the vial adapter. The lower risk of incomplete attachment and misalignment is due to the reduced possible angle of receiving the vial cap within the vial adapter skirt. By the term incomplete attachment is meant incomplete penetration of the entire longitudinal length of the piercing member, or at least the length of the 15 angledspiked open end through the piercing member, and by the term misalignment is meant a deviation from a perpendicular contact between the piercing member and the upper surface of the vial crown, e.g. a deviation from a vertically oriented piercing member and a horizontally oriented upper surface as shown in FIG. 1.

For example, the vial adapter shown in FIG. 1A may receive the vial cap at an angle to the vertical line formed by the longitudinal piercing member in FIG. 1A. This is indicated by the three sections of the pie chart placed symmetrically around the vertical piercing member in FIG. 1A. If the angle of the piercing member is deviating to a first degree from vertical (shown in dark dots), the piercing member may penetrate the cap at a non-perpendicular angle, and the vial adapter is consequently misaligned and incompletely attached. If the angle of the piercing element is deviating to a larger second degree from vertical (shown in stippled), the inner walls of the vial adapter chamber restrict and partly correct the angle, such that the piercing member may penetrate the cap at a similar non-perpendicular angle as for the first degree of misalignment. If the angle of the piercing member is deviating to an even larger third degree (shown in ligth dots), the vial adapter and vial are not attached at all.

The longer skirt of the vial adapter embodied in FIG. 1B facilitates that the vial adapter may essentially only receive the vial cap along the vertical line formed by the longitudinal piercing member in FIG. 1B, and thus, no angle of receiving the vial cap within the vial adapter skirt is possible. If the angle of the piercing element is deviating to a minor first degree from vertical (shown in dark dots), the inner walls of the vial adapter chamber restrict and correct the angle to the vertical line, such that the piercing member penetrates the cap at a perpendicular angle. If the angle of the piercing member is deviating to a larger degree from vertical (shown in light dots), the vial adapter and vial cannot attached at all, as indicated by the pie chart placed symmetrically around the vertical piercing member in FIG. 1B.

To further reduce the risk of misalignment and incomplete attachment between vial and vial adapter, and to ensure a central piercing of the upper surface of the vial crown, the vial adapter is advantageously form fitted to the vial, such that the vial adapter is configured for snugly, slidably receiving the vial. Conventional vials, as shown in FIG. 1, comprise a separate crown and vial body, where the crown and body have different dimensions, and typically the vials are cylindrical having a crown with a first cylindrical shape, and a vial body with a second larger cylindrical shape. Thus, the upper surface of the vial crown is typically circular with a circular and concentrically placed pierceable septum.

Hence, advantageously, the vial adapter comprises two chamber parts in axial extension of each other, as shown in FIG. 1B, wherein the first chamber part 2.2 is configured for slidably receiving and encasing at least a part of the vial crown, and the second chamber part 2.3 is configured for slidably receiving and encasing at least a part of the vial body. For further improved form fitting, the first andor second chamber parts are configured for slidably receiving and expanding with a compressive force in response to the vial receival. Advantageously, the second chamber part is configured for slidably receiving and expanding with a compressive force in response to at least a part of the vial body.

Further advantageously, the first chamber part 2.2 is a first cylindrical part, and the second chamber part 2.3 is a second cylindrical part, such that the vial adapter comprises two cylindrical parts in axial extension of each other, which are form fitted to a conventional vial crown and vial body. It follows that the direction of the axial extension corresponds to the axial orientation defined by the piercing member, i.e. the longitudinal direction of the piercing member andor the longitudinal direction of the vial. Hence, the first chamber part is located at the proximal end of the adapter, and the second chamber part is located at the distal end of the adapter.

To reduce the possible angle of receiving the vial cap within the vial adapter skirt, and hence to reduce the risk of misalignment between vial adapter and vial, and to ensure a central piercing of the upper surface of the vial crown, including the septum, the chamber parts are advantageously configured for slidably receiving a larger portion of the vial crown and, and a larger portion of the vial body.

In an embodiment of the disclosure, the second chamber part is configured for slidably receiving at least 20% of the vial body, such as at least 25, 30, 40, 50, 60, 70, 80, 90, or 100% of the vial body. In another or further embodiment, the first chamber part is configured for slidably receiving at least 50% of the vial crown, such as at least 60, 70, 90, or 100% of the vial crown.

To improve the simplicity, robustness and fail-safe user friendliness of the vial adapter, it was found advantageous that the first chamber part andor the second chamber part comprises a coherent cylindrical chamber wall. Specifically, it was found advantageous that the second chamber part, or at least the distal part of the second chamber part, is a coherent cylindrical chamber wall, i.e. without any openings and edges, such as axially oriented slits or deformable surface sections which may form openings or edges when deformed, within the chamber wall, which may increase the risk of user damage. Advantageously, the first andor second chamber parts, as well as the transition zone between the first and second chamber parts, are coherent and form a coherent and smooth structural surface, where the chamber is only deformable to a limited degree, i.e. the chamber walls are configured to not deform by forming hinged zones or kinked zones.

In an embodiment of the disclosure, the first chamber part comprises a coherent cylindrical chamber wall. In a further embodiment, the second chamber part comprises of a coherent cylindrical chamber wall. In a further embodiment, the second chamber part consists of a coherent cylindrical chamber wall.

However, in addition or alternatively, the first andor the second chamber part may comprise one or more slits, to facilitate the manual insertion and receival of the vial body within the adapter. FIG. 1B shows an embodiment, where the vial adapter 2 comprises four axially oriented slits 3.3 placed around the vial skirt, where two of the slits are seen in the front view (shown with solid line), and two of the slits are placed on the backside (shown with stipled line).

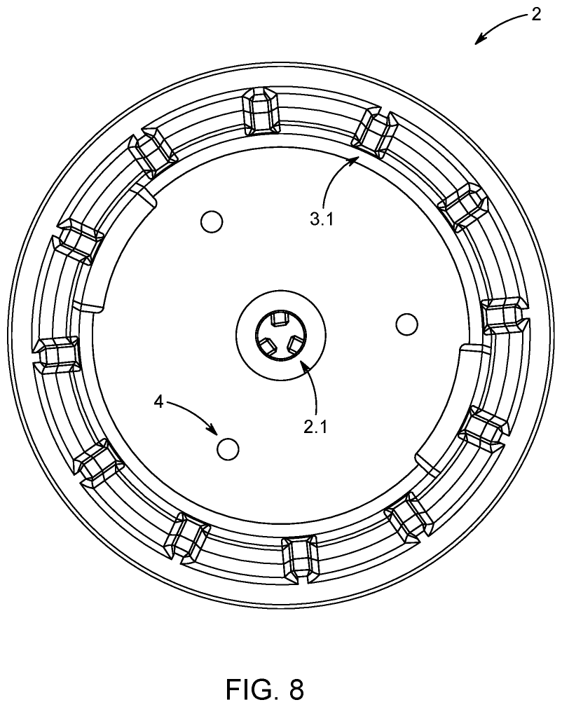

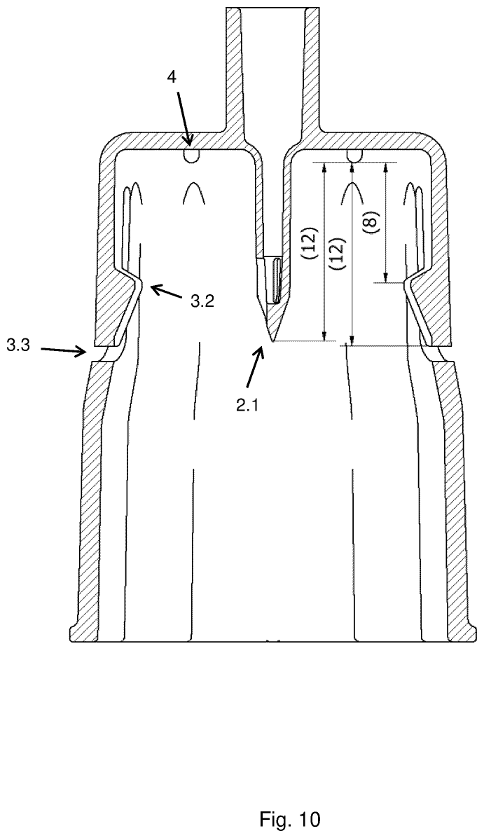

To ensure a more reliable and uniform complete insertion of the vial within the vial adapter, the vial adapter advantageously comprises one or more spacers 4 placed at the top wall of the chamber, as e.g. seen in FIG. 8 showing a perspective view of an embodiment of a vial adapter according to the present disclosure, as seen from a bottom perspective and into the chambers. The one or more spacers facilitate the presence of a particularly sensory input upon complete insertion. For a reliably and uniform sensory input on complete insertion, the top chamber wall advantageously comprises between 2-10 spacers, and the spacers are preferably rotation symmetrically placed, e.g. having a 120 degrees rotational symmetry as seen in FIG. 8. The spacers may have any suitable shape, which are flexibly and simple to manufacture, such as spherical or semi spherical. Advantageously, the distal end of the spacer 4 has a semi spherical shape, as seen in the cross-sectional view of an embodiment of a vial adapter according to the present disclosure, in FIG. 10.

In an embodiment of the disclosure, the first chamber part has a top chamber wall comprising one or more spacers, such as between 2-10 spacers, more preferably 3, 5 or 7 spacers. In a further embodiment, the distal end of the spacers have a spherical or semi spherical shape.

To further reduce the risk of misalignment and incomplete attachment between vial and vial adapter, the vial adapter is advantageously essentially form fitted to the vial, such that the vial adapter is configured for snugly, slidably receiving the vial, i.e. both the vial crown and at least partially the vial body. Since a vial crown and body typically are cylindrical with the crown having a smaller diameter, the chamber parts are advantageously also cylindrical, and where the internal diameter of the first chamber part is smaller than the internal diameter of the second chamber part.

In an embodiment of the disclosure, the two chamber parts are cylindrical, and wherein the internal diameter of the first chamber part is smaller than the internal diameter of the second chamber part. In a further embodiment, the first chamber part has an internal diameter of between 10-50 mm, more preferably between 15-40 mm, and most preferably between 20-30 mm, such as 23 or 25 mm. In a further embodiment, the second chamber part has an internal diameter of between 10-50 mm, more preferably between 20-40 mm, and most preferably between 25-30 mm, such as 27 or 29 mm.

### AXIALLY ORIENTED RIBS

To further reduce the risk of misalignment between vial adapter and vial, and to ensure a central piercing of the upper surface of the vial crown including the septum, the first chamber part 2.2 andor the second chamber part 2.3 advantageously comprises one or more radially inwardly ribs 3, such as one or more axially oriented ribs 3.1, as illustrated in FIG. 2, showing an example of axially oriented ribs within the first chamber part. The ribs are axially oriented, i.e. oriented parallel to the longitudinal axis of the vial adapter, and parallel to the piercing member of the vial adapter.

In an embodiment of the disclosure, the one or more radially inwardly ribs are axially oriented.

Due to the two chamber parts being in axial extension, it is particularly advantageous that the complete insertion of the vial within the vial adapter, corresponding to complete penetration of the entire length of the piercing member, is detectable e.g. by a sensory input or assembly force. For example, complete insertion may be detected as an assembly force, e.g. a change in a force, such as a change in a frictional force. Thus, advantageously, the axially oriented ribs are configured as vial crown retainers andor vial body retainers, elastically compressing the vial crown andor vial body, and frictionally engaging the vial crown. Further advantageously, the ribs are configured as wedges, where the frictional force changes upon insertion. Hence, the ribs are configured as vial retainers, which do not rely on a latching mechanism.

In an embodiment of the disclosure, the axially oriented ribs are configured as vial crown retainers andor vial body retainers, such as wedges. In a further embodiment, the axially oriented ribs are configured to be elastically compressive outwardly towards the chamber wall.

Hence, advantageously, the axially oriented ribs are abutting the side of the vial crown andor the vial body in an elastic compressive manner, such that the ribs are not only guiding and stabilising the sliding receival of the vial crown andor vial body, but also fixing or retaining the vial crown andor the vial body, in a wedge manner.

Advantageously, the ribs are at least configured to be elastic compressive outwardly towards the chamber wall, such that when e.g. a vial crown is received within the adapter, the ribs are elastically compressed towards the chamber wall, and exert a compressive force towards the vial cap. Thus, the abutting parts of the ribs will have a vial retention function, and the ribs are configured as vial retainers or vial retaining means. Similarly, the ribs may retain the vial body. The vial retaining means will further reduce the risk of misalignment between vial adapter and vial.

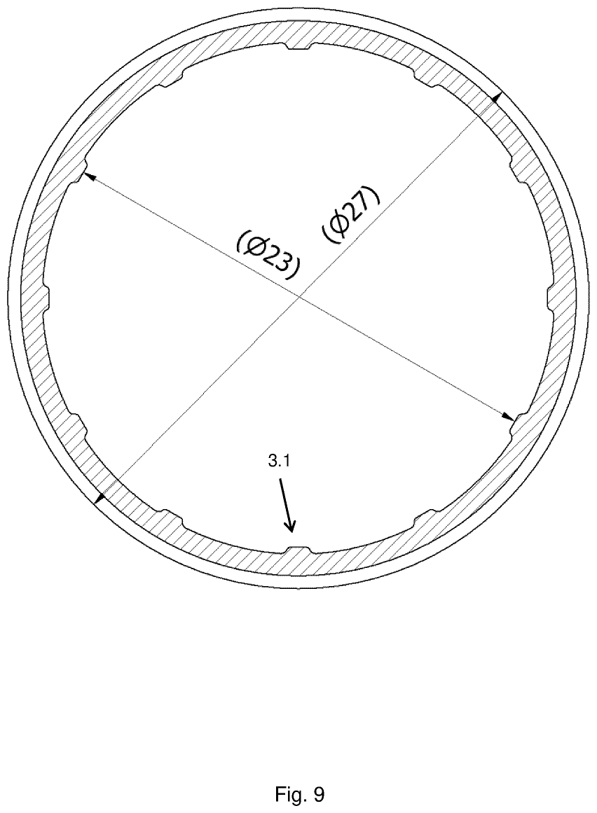

To further improve the insertion and retainment of the vial, a side of the axially oriented ribs facing the vial crown andor body, advantageously comprises a planar or annular shaped section for abutting andor partially engaging with the vial crown andor body. Hence, the contact interface between the axially oriented rib and the vial is advantageously planar and not linear. For example, the side facing the vial crown may be planar and rectangular, as seen in the perspective view of FIG. 2. The planar or annular section of the axially oriented rib on the side facing the vial crown andor body is also seen in the cross-sectional view of FIG. 9, showing an embodiment of a vial adapter according to the present disclosure. In the cross-sectional view of FIG. 9, the axially oriented ribs have an isosceles trapezoidal shape with the shorter base side facing the vial. Alternatively, the axially oriented ribs may have a rectangular shape as seen in cross sectional view, as the ribs seen in FIG. 2, or trilateral trapezoidal, or squared. Preferably, the axially oriented ribs do not have a triangular shape with an apex facing the vial, as seen in cross sectional view, such that the interface between the axially oriented rib and the vial becomes linear.

In an embodiment of the disclosure, the axially oriented ribs comprises a planar or annular shaped section, as seen in cross-sectional view, for engaging with the vial crown or vial body. In a further embodiment, the axially oriented ribs have a cross sectional shape selected from the group of: isosceles trapezoidal, trilateral trapezoidal, rectangular, or squared.

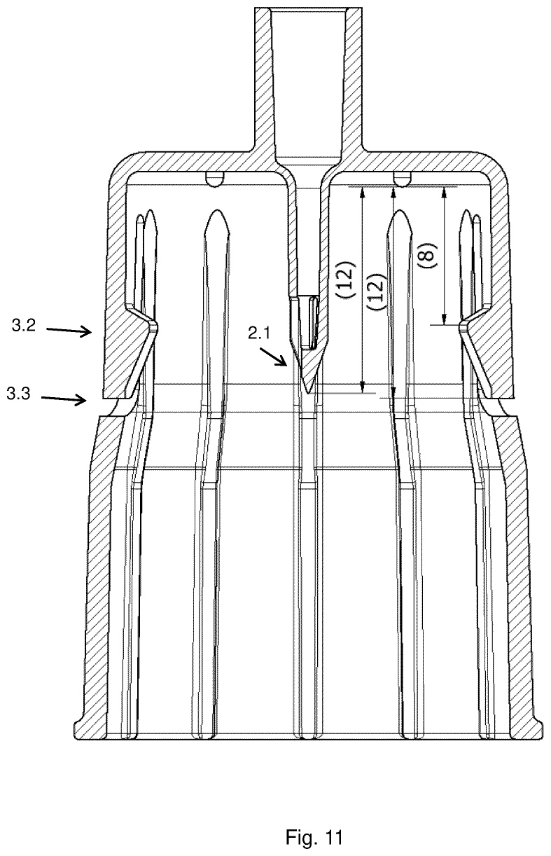

To further improve the insertion and retainment of the vial, the axially oriented ribs are advantageously disposed along the length of both the first and second chamber parts, corresponding to the entire length of the two chambers in extension, as indicated in FIGS. 11-13.

The strength of the sensory input upon complete insertion, will depend on the number, size, shape, and configuration of the axially oriented ribs.

Advantageously, the adapter comprises two or more axially oriented ribs, which are arranged rotational symmetric around the chamber walls, for example by being arranged at an equal interval along the circumferential direction of the cylindrical chamber part. For example, the first cylindrical part may comprises four axially oriented ribs arranged at 90 degrees distance, such that the ribs are arranged rotational symmetric with a 4-fold rotation axis as seen from the axial direction in FIG. 2.

In an embodiment of the disclosure, the adapter comprises two or more axially oriented ribs, such as three, four, five, six, seven, eight, nine, or ten axially oriented ribs, and preferably four axially oriented ribs. In a further embodiment, the axially oriented ribs are arranged rotational symmetric within the cylindrical part, such as the first cylindrical part. In a further embodiment, the axially oriented ribs are arranged at an equal interval along the circumferential direction of the cylindrical part, such as the first cylindrical part.

The axially oriented ribs may extend inwardly of the chamber wall, i.e. protrude from the inner chamber wall and towards the chamber central axis or piercing member, at different angles. For example, as shown in FIG. 2, the ribs may extend radially inwardly in a direction similar to a radial bike spoke, where the spoke extends from the circular perimeter towards a central hub. Thus, the ribs protrude perpendicular from the inner chamber wall, as seen from the axial direction in FIG. 2.

Similar to a bike spoke, where the spokes may be mounted radially to the hub or tangentially to the hub, the ribs advantageously extend inwardly with a tangential component. The inwardly extension of the rib may thus comprise a radial and tangential component. The inwardly extension of the rib may be defined by the radial angle, which is defined as the angle to the tangent to the chamber wall. Thus, the ribs shown in FIG. 2 has, similar to radial bike spoke, a radial angle of 90 degrees.

To ensure a more flexible and slidable receival of the vial crown andor vial body within the chamber, as well as to improve the sensory input on complete insertion, the ribs advantageously extend inwardly with a radial angle of below 90 degrees, and further advantageously all of the ribs extend inwardly with the same radial angle. Further, as shown in FIG. 2, the ribs may extend linearly inwardly, as seen in cross section from the axial direction, or they may have an inwardly curved shape, such that the ribs are arranged in a similar manner as the blades of an impeller, as seen from the axial direction.

In an embodiment of the disclosure, the axially oriented ribs extend inwardly with a radial angle of 90 degrees. In another embodiment, the axially oriented ribs extend inwardly with a radial angle of below 90 degrees, preferably an angle of below 80, 70, 50, 40, or 30 degrees. In a further embodiment, the axially oriented ribs extend inwardly with the same radial angle.

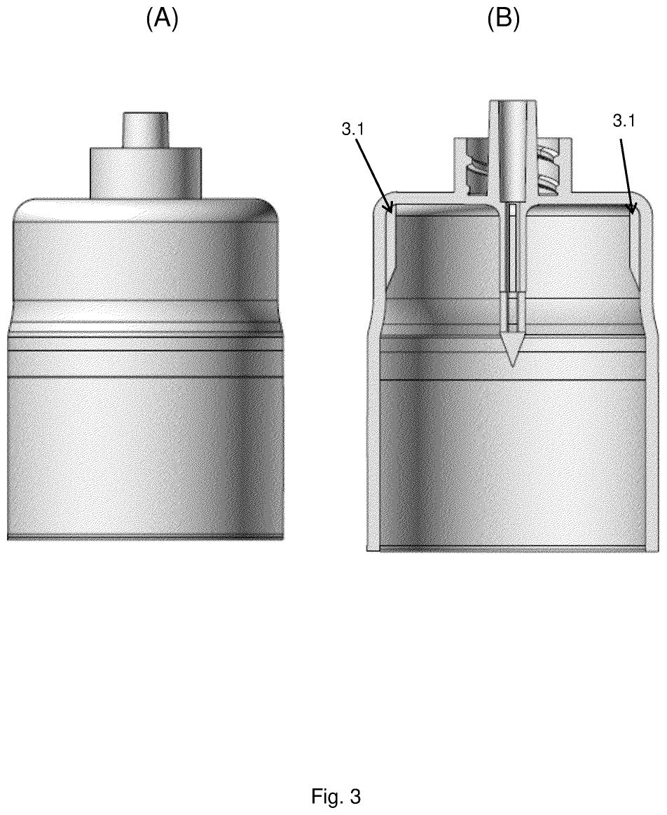

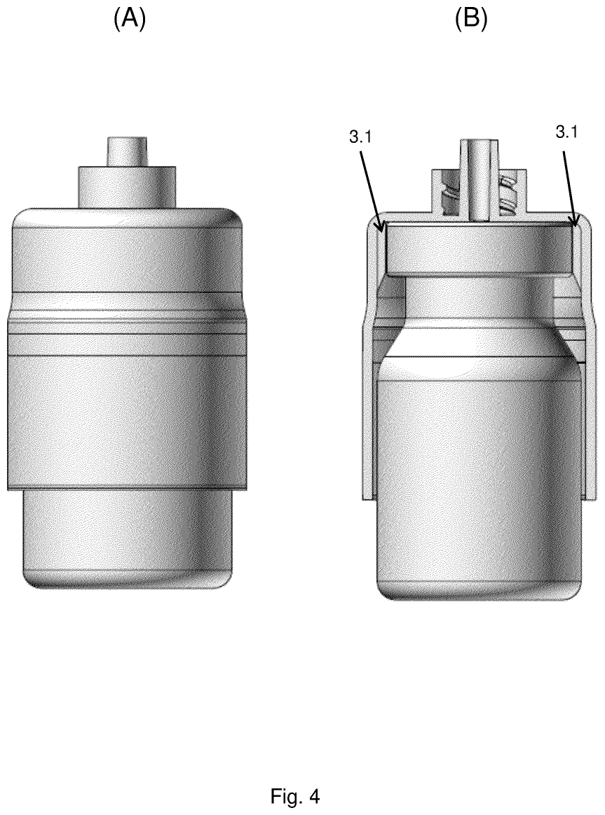

FIGS. 3 and 4 show embodiments of the vial adapter according to the present disclosure without and with a vial attached. FIG. 4B shows a cross-sectional view of an embodiment, where an upper part of the axially oriented ribs is abutting or compressing the lateral sides of the crown. By the term “upper part of the rib” is meant the longitudinal part of the rib proximal to the chamber top wall or ceiling, and distal to the chamber opening.

To ensure a more flexible and slidable receival of the vial crown andor vial body within the chamber, as well as ensure complete insertion and reduce the risk of incomplete 25 attachment between the adapter and the vial crown andor vial body, the dimensions of the rib advantageously changes along the axial orientation. For example as shown in FIGS. 2-4, the ribs extend inwardly from the chamber wall with a smaller dimension at the lower axial section of the rib, proximal to the chamber opening, and extend with a larger dimension at the upper axial section of the rib, proximal to the chamber top or 30 ceiling. For example the inwardly extension of the ribs may change linearly along a part of the axial orientation, as shown in FIGS. 2-4.

The change in the inwardly extension of the ribs facilitate a more easy slidably receival of the vial crown within the chamber, and may further result in a physically sensed change of the force or the assembly force needed for insertion or receival of the vial, upon fully insertion, similar to a spring force. Thus, the risk of incomplete attachment may be further reduced, since complete attachment is noticeable by the user performing the attachment. This is particularly advantageous for vial caps having deviations in the vial dimensions, as incomplete attachment may be monitored for caps with different tolerances.

In an embodiment of the disclosure, the inwardly extension of the axially oriented ribs changes along the axial extension. In a further embodiment, the inwardly extension of the ribs are smaller towards a distal end. In a further embodiment, the inwardly extension of the ribs changes linearly along at least a part of the axial extension.

For improved vial retention and sensory input on complete insertion, and simultaneously to ensure flexible and slidable receival of the vial crown within the chamber with reduced risk of incomplete attachment, the ribs advantageously comprises a curved line portion as seen from an axial direction. For example, the ribs advantageously are shaped as impeller blades as seen from an axial direction.

In an embodiment of the disclosure, the axially oriented ribs comprises a curved line portion, as seen from an axial direction. In a further embodiment, the axially oriented ribs are shaped as impeller blades, as seen from an axial direction.

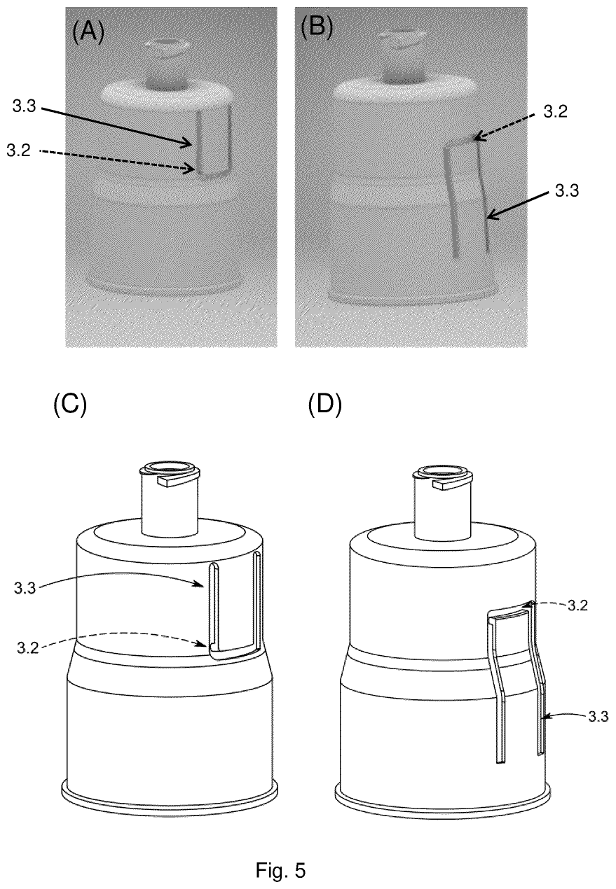

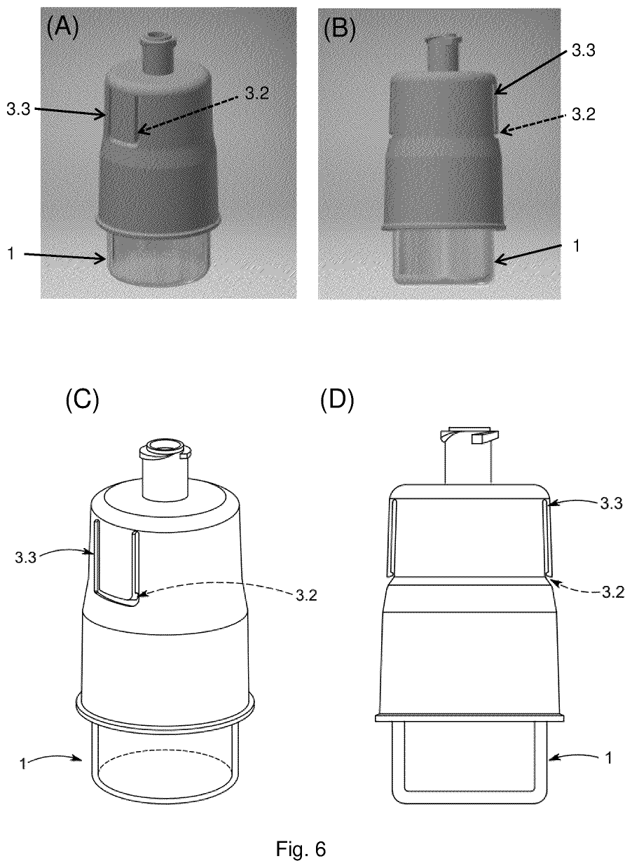

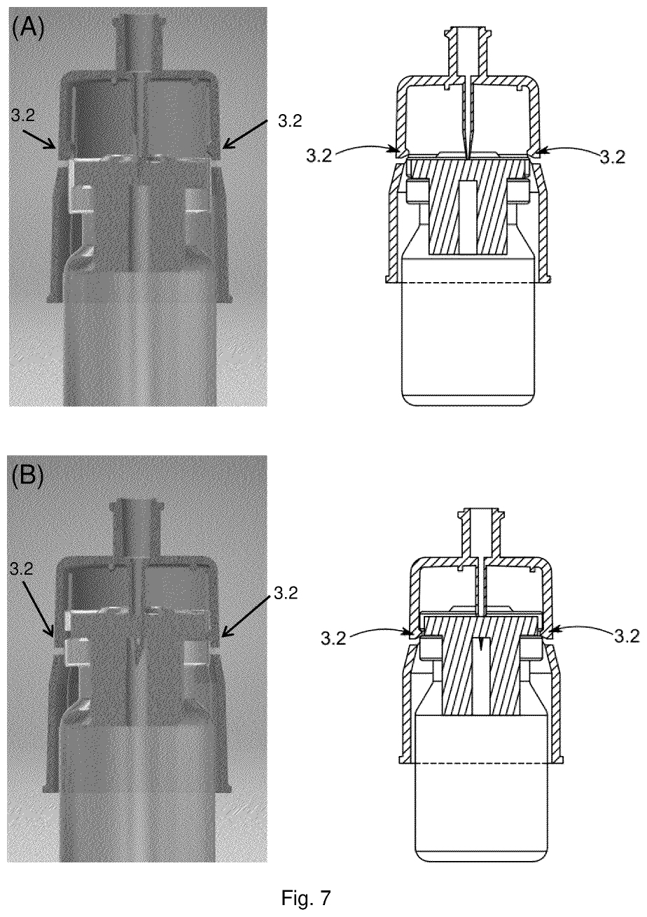

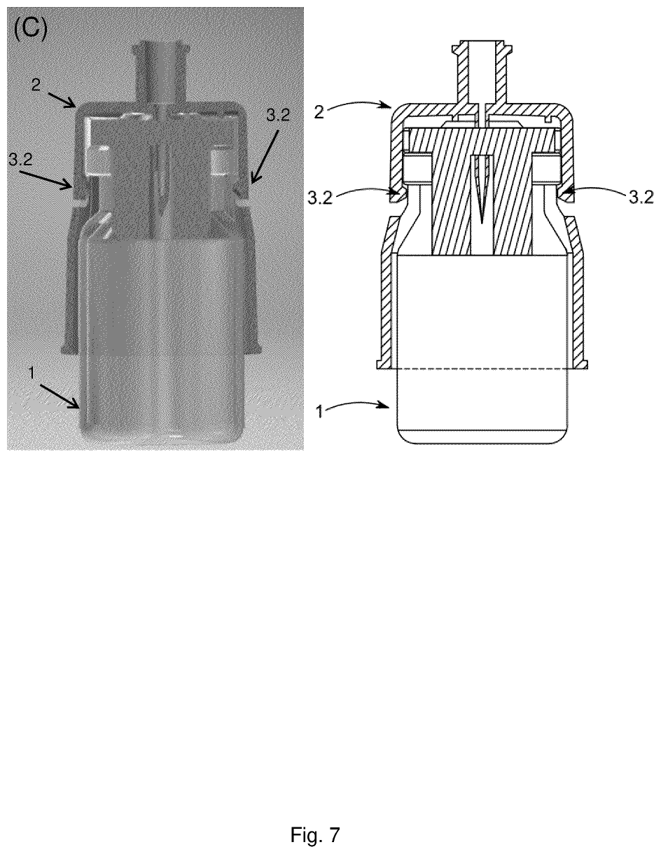

Circumferentially oriented ribs To reduce the risk of misalignment between vial adapter and vial, and to improve the sensory input on complete insertion of the vial, the first chamber part 2.2 andor the second chamber part 2.3 may in addition or alternatively comprise one or more radially inwardly ribs 3, such as one or more circumferentially oriented ribs 3.2, as illustrated in FIGS. 5-6, which show embodiments of the adapter separate from a vial (FIG. 5), and attached to a vial (FIG. 6). For example, the circumferentially oriented rib extends along a part of the inner circumference of the first chamber wall, as indicated by the stippled arrow in FIGS. 5-6. FIG. 7 shows an embodiment of the vial adapter in cross-sectional view, when a vial is inserted: (A) shows the vial crown within the second chamber part, (B) shows the vial crown entering the first chamber part, and (C) shows complete insertion.

WO 2022112543 14 PCTEP2021083281

In an embodiment of the disclosure, the one or more radially inwardly ribs are circumferentially oriented ribs extending along at least a part of the circumference of the chamber wall, such as the first chamber wall andor the second chamber wall.

Due to the two chamber parts being in axial extension, it is particularly advantageous that the complete insertion of the vial within the vial adapter, corresponding to complete penetration of the entire length of the piercing member, is detectable e.g. by a sensory input or assembly force. For example, complete insertion may be detected as a change in a force, e.g. a frictional force, a spring force, or a released force, such as a snap fit. Thus, advantageously, the circumferentially oriented rib(s) are configured as vial crown retainers, e.g. by being elastically flexible, and configured to engage with the vial crown in a snap fit. In addition or alternatively, the circumferentially oriented rib(s) may be configured as vial body retainers.

In an embodiment of the disclosure, the at least one circumferentially oriented rib is configured as a vial crown retainer, andor a vial body retainer. In a further embodiment, the at least one circumferentially oriented rib is configured for snap fitting over the vial crown. In a further embodiment, the at least one circumferentially oriented rib is flexible.

The risk of misalignment and the strength of the sensory input upon complete insertion, will depend on the number, size, shape, and configuration of the circumferentially oriented ribs. For example, the adapter may advantageously comprises two circumferentially oriented ribs, placed at opposite sides of the first chamber part, as 25 illustrated in FIG. 7.

Advantageously, in an embodiment of the disclosure, the adapter comprises one or more circumferentially oriented ribs, such as two, three, or four circumferentially oriented ribs. In a further embodiment, the at least one circumferentially oriented rib 30 extend around below 50% of the circumference of the first chamber wall, andor the second chamber wall, such as below 40%, 30%, 25%, 20%, 15%, 10% or 5%. In a further embodiment, the length of the circumferentially oriented ribs are below 2 cm, such as below 1.5 cm or 1 cm.

WO 2022112543 15 PCTEP2021083281

To ensure a more flexible and slidable receival of the vial crown and vial body within the chamber, as well as to improve the sensory input on complete insertion, the circumferentially oriented ribs advantageously extend inwardly with an angle, such as an angle of 90 degrees or an inclined angle, which is different from 90 degrees. Preferably, the inclination is towards the first chamber part or towards the proximal end, thereby facilitating slidable insertion and that the ribs are not acting as a barb. Further advantageously, the ribs have a rectangular or triangular shape, as seen in the cross- sectional view of FIG. 7. The circumferentially oriented ribs may have any triangular shape, as seen in cross sectional view, such as equilateral triangular, isosceles triangular, and scalene triangular. In a preferred embodiment, the ribs have a scalene triangular shape, i.e. an asymmetric triangular shape with all sides having different lengths, and with the shorter leg of the triangle facing the top chamber wall, as e.g. seen in FIG. 10. This may further improve the slidable receival of the vial within the chamber, as well as the sensory input upon complete insertion.

In an embodiment of the disclosure, the at least one circumferentially oriented rib extend inwardly with an angle of 90 degrees. In another embodiment, the at least one circumferentially oriented rib extend inwardly with an inclined angle towards the chamber part. In a further embodiment, the at least one circumferentially oriented rib 20 has a rectangular or triangular shape, as seen in cross-sectional view.

In another and further embodiment of the disclosure, the circumferentially oriented ribs have a triangular shape selected from the group of: equilateral triangular, isosceles triangular, and scalene triangular, and preferably is scalene triangular with the shorter 25 leg of the triangle facing the top chamber wall.

The adapter is advantageously configured for snap fitting over a vial opening. Consequently, the circumferentially oriented rib(s) may be located within the first chamber part at different distances from the distal end. For example, the circumferentially oriented rib(s) may be located at the distal end of the first chamber part, as illustrated in FIG. 5A, or at a distance from the distal end, as illustrated in FIG. 5B. Advantageously, the circumferentially oriented ribs are located at the distal end of the first chamber, i.e. in the vicinity of the transition between the first and second chamber parts, as e.g. seen in FIG. 10.

WO 2022112543 16 PCTEP2021083281

In an embodiment of the disclosure, the at least one circumferentially oriented rib is placed at the distal end of the first chamber part. In another embodiment, the at least one circumferentially oriented rib is placed at a distance from the distal end of the first chamber part, such below 50%, 40%, or 30% of the first chamber length from the distal end.

To further improve the insertion, and particularly the sensory input on complete insertion, and the snap fit attachment, the circumferentially oriented rib(s) are advantageously located adjacent to a circumferentially oriented slit, and one or more at least partially axially oriented slits. For example, the horizontal, circumferentially oriented ribs shown in FIGS. 5-6 may be located adjacent to a horizontally oriented slit connected to two vertically oriented slits, as seen in FIGS. 5-6.

In an embodiment of the disclosure, the at least one circumferentially oriented rib is adjacent to at least one circumferentially oriented slit. In a further embodiment, the at least one circumferentially oriented slit is connected to at least one partially axially oriented slit. In a further embodiment, the at least one circumferentially oriented slit is connected to two or more axially oriented slits. In a further embodiment, the two or more axially oriented slits extend towards a proximal end andor a distal end.

To further improve the sensory input on complete insertion, and the user friendliness of the snap fit attachment, the dimensions of the slits may be optimised.

In an embodiment of the disclosure, the length of the circumferentially oriented slit is 25 similar or smaller than the length axially oriented slit, such as at least 70%, 60%, 50%, 40%, or 30% smaller. In a further embodiment, the circumferentially oriented slit is located within the first chamber part, and the axially oriented slit(s) are located within the first chamber part andor the second chamber part.

30 For easy handling and storage, the vial adapter may comprise a further circumferentially oriented rib, which extends radially outwardly of the chamber wall. Preferably, the further circumferentially oriented rib is placed at the distal end of the second chamber, as e.g. seen in FIGS. 10-12, thereby forming a supporting base for a storage configuration.

WO 2022112543 17 PCTEP2021083281

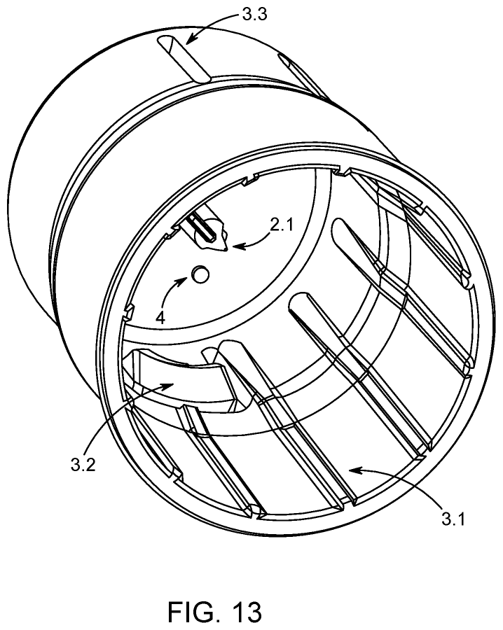

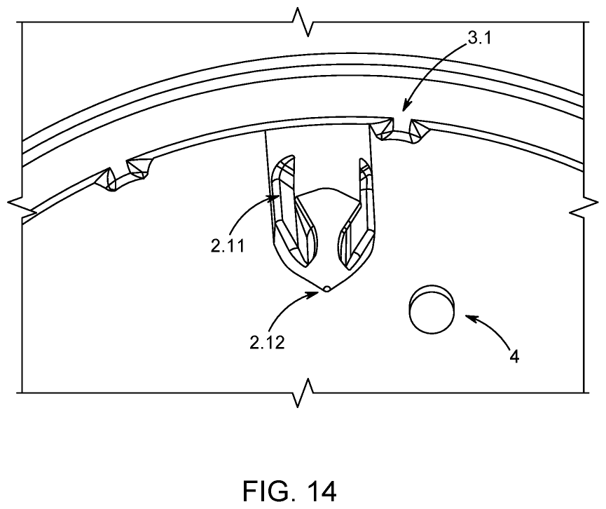

Piercing member A vial adapter implicitly comprises a piercing member 2.1 for piercing the septum of the cap, and facilitating liquid transfer between the vial interior and the adapter port. Hence, the piercing member may comprise a hollow elongated structure, such as a hollow cylindrical shape, as seen in FIGS. 2-3. It was surprisingly found that the tip 2.12 of the piercing member advantageously has a conic shape, similar to a pointed pencil, as seen in FIGS. 13-14 showing perspective views of an embodiment of a vial adapter according to the present disclosure, as seen from a bottom perspective. Hence, the tip of the piercing member has a smooth surface and does not comprise facets, in the manner of a pyramid. The shape facilitates that an elastic septum may be resealable pierced, because the septum membrane is not cut or slashed open by facets, as it would be by a pyramid shaped tip, but instead is opened by the compressive forces occurring in contact with the smooth surfaced cone.

In an embodiment of the disclosure, the piercing member comprises a cylindrical section and a conic shaped tip section.

The piercing member further comprises one or more openings 2.11 for the liquid transfer to take place at the vial adapter interface. For efficient liquid transfer and to reduce the pressure drop across the vial adapter, the piercing element advantageously comprises multiple openings, such as preferably between 2-8 openings. For example, the piercing element comprises 3 openings 2.11 as seen in FIG. 8 (from a bottom perspective) and FIGS. 13-14 (perspective view).

In an embodiment of the disclosure, the piercing member comprises multiple openings, more preferably between 2-8 openings, such as 3, 4, or 5 openings.

To enable both efficient liquid transfer and piercing strength, the openings 2.11 are advantageously located rotational symmetric around the piercing element, e.g. having a 120 degrees rotational symmetry, as seen in FIGS. 8, 13-14, and the openings are further preferably placed at proximal distance to the distal tip 2.12 of the piercing element. Further advantageously, the openings are linear slits disposed along at least a part of the cylindrical section and at least a part of the conic section of the piercing element, as most clearly seen in FIG. 14.

WO 2022112543 18 PCTEP2021083281

In an embodiment of the disclosure, the openings are shaped as linear slits disposed along at least a part of the cylindrical section and the conic section of the piercing member.

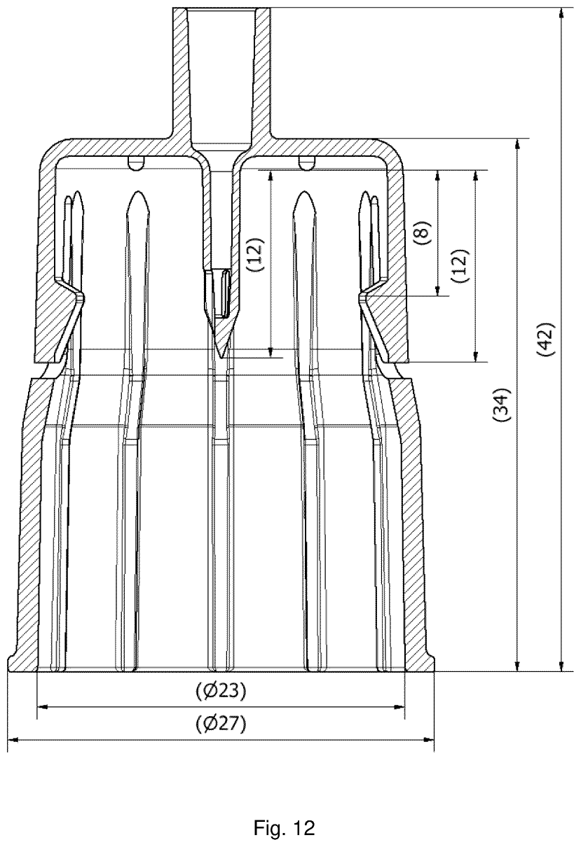

It was further surprisingly found that the combined relative positions within the chamber skirt of the distal tip 2.12 of the piercing element, the circumferentially oriented slits 3.3, andor the circumferentially oriented ribs 3.2, affect the vial adapter performance, particularly the sensory input on complete insertion, the fluid transfer efficiency, and the piercing strength. FIG. 10 shows a cross-sectional view of an embodiment of a vial adapter according to the present disclosure, and FIGS. 11-12 show cross-sectional perspective view of an embodiment of vial adapter according to the present disclosure, where preferred exemplary dimensions are indicated.

In an embodiment of the disclosure, the distal tip of the piercing member is located between 25-50% from the top wall relative to the chamber lengths, more preferably between 30-45%, such as 35, 37, 40, or 44%

In an embodiment of the disclosure, the circumferentially oriented slits are located at essentially the same distance from the top wall relative to the chamber lengths, as the distal tip of the piecing member.

In an embodiment of the disclosure, the circumferentially oriented ribs are located between 15-30% from the top wall relative to the chamber lengths, more preferably between 20-30%, such as at least 23%.

Liquid transfer The vial adapter of the present disclosure is advantageously applied for medicinal vials or cartridges. A medicinal vial comprises a bioactive agent, where a “bioactive agent” is defined as any agent, drug, compound, composition of matter or mixture which 30 provides some pharmacologic, often beneficial, effect that can be demonstrated in vivo or in vitro. An agent is thus considered bioactive if it has interaction with or effect on a cell tissue in the human or animal body. As used herein, this term further includes any physiologically or pharmacologically active substance that produces a localized or systemic effect in an individual. Bioactive agents may be a protein, such as an enzyme. 35 Further examples of bioactive agents include, but are not limited to, agents comprising

WO 2022112543 19 PCTEP2021083281 or consisting of an oligosaccharide, a polysaccharide, an optionally glycosylated peptide, an optionally glycosylated polypeptide, an oligonucleotide, a polynucleotide, a lipid, a fatty acid, a fatty acid ester and secondary metabolites. It may be used either prophylactically, therapeutically, in connection with treatment of an individual, such as a human or any other animal. The term “bioactive agent” as used herein does not encompass cells, such as eukaryotic or prokaryotic cells.

Bioactive agents, such as thrombin, are typically expensive and stored in a solid andor dried state to ensure chemical stability, longer storage times, and thus lower material waste. Advantageously the bioactive agent is a lyophilized agent, such as lyophilized thrombin. Lyophilization, is also known as freeze-drying, and involves dehydration of the bioactive agent, such that it is preserved and stored in a dried solid state. Thus, lyophilization provides an efficient storage form. However, for the lyophilized bioactive agent to be applied by injection, the lyophilized agent must be reconstituted by mixing with a liquid.

It is known in the art that the storage life of injectable substances, such as thrombin, is increased when the substance is stored in a powdered state. Lyophilization is one way of producing a powdered substance from a liquid based material. It involves a rapid freezing of the material at a very low temperature followed by a rapid dehydration by sublimation in a high vacuum.

The resulting lyophilized substance is typically stored in a glass vial or cartridge which is closed by a cap, such as a rubber stopper or septum. It is necessary to reconstitute the powdered or solid substance prior to administration. This is accomplished by mixing the powdered substance with a suitable diluent or liquid.

In an embodiment of the disclosure, the bioactive agent is a dried or lyophilized substance. In a further embodiment, the bioactive agent comprises thrombin. In a further embodiment, the bioactive agent comprises or consists of lyophilized thrombin.

In one embodiment of the disclosure, the thrombin is recombinant thrombin. In one embodiment of the disclosure, the thrombin is human thrombin.

WO 2022112543 20 PCTEP2021083281

The bioactive agent is advantageously reconstituted by a liquid capable of dissolving the agent or keeping the agent in essential stable suspension. Further advantageously, the liquid is of a type which acts as a diluent, such that the concentration of the bioactive agent can be easily adjusted. For example, thrombin may be easily dissolved andor suspended by water, sterile water, saline water, sterile saline, or a mixture of water and glycerol.

In an embodiment of the disclosure, the liquid is a diluent. In a further embodiment, the liquid is an aqueous medium selected from the group of: water, glycerol, sterile water, saline, sterile saline, a calcium chloride solution, a buffered aqueous solution, and combinations thereof.

Reconstitution of a dry preparation of a bioactive agent such as thrombin is traditionally performed using a syringe with a needle to withdraw the diluent from one separate vial and inject it into another separate vial containing the dry thrombin, whereupon the latter vial is shaken or swirled to thoroughly mix the two constituents. The syringe with needle is then used to withdraw from this vial the desired amount of reconstituted bioactive agent. Because two separate containers are used, the person reconstituting the bioactive agent must be certain and precise to mix the correct amounts such that a proper concentration of the mixture results. Furthermore, the person reconstituting the bioactive agent must be fast, since the time consumption may be critical during medical procedures, e.g. in an Operation Room (OR) where incorrect concentration dosages of the bioactive agent may cause increased blood loss and longer operating time of the surgical procedure.

To ensure fast, simple, and fail-safe transfer of the diluent and mixture to andor from the vials, a vial adapter according to the present disclosure is advantageously used for one or more of the vials. Furthermore, the absence of a snap-fit over the vial cap provides a more flexible fastening of the vial adapter to the vial, thereby facilitating 30 faster attachment and detachment.

The liquid mixture may be further transferred from the second vial, advantageously assisted by an attached vial adapter. For example, if the bioactive agent is of a type, which acts as a clotting agent, such as thrombin, the bioactive agent is further mixed 35 into a flowable paste to act as a haemostatic matrix. For the paste to act as an efficient

WO 2022112543 21 PCTEP2021083281 haemostatic matrix, the liquid mixture is transferred to the paste to ensure sufficient uniform mixing of the bioactive agent within the paste.

Thrombin is added to the paste of the present disclosure in an amount sufficient to ensure effective haemostasis of the paste. In one embodiment thrombin will be present at a concentration in the range of about 100 Uml paste to about 500 IUm1 paste, such as about 150 IUm1 paste to about 450 Uml paste, for example about 200 IUm1 paste to about 400 Uml paste, such as about 250 Uml paste to about 350 IUm1 paste.

In one embodiment, thrombin will be present in the paste at a concentration in the range of about 50 I Ug paste to about 5000 I Ug paste, preferably between about 100 IUg paste to about 1000 IUg paste, such as between about 200 IUg paste to about 800 IUg paste.

Advantageously, the components are pre-loaded in the syringe, vials and containers in predefined amounts and ratios. Thus, the steps of measuring the correct amount of the components are avoided, and a predefined amount of liquid mixture or paste is rapidly, easily, and conveniently produced. However, to ensure correct amounts of the mixtures, complete liquid transfer is needed, and this is facilitated by the simple and fail-safe vial adapter according to the present disclosure.

Reference numbers 1 - Vial 1.1 — Vial body 1.2 — Vial bottom 1.3 — Vial shoulder 1.4 — Vial neck 1.5 — Vial crown or vial cap 1.6 — Cap septum 2 — Vial adapter 2.1 — Piercing member 2.11 — Piercing member opening 2.12 — Piercing member tip 2.2 — First chamber part 2.3 — Second chamber part

WO 2022112543 22 PCTEP2021083281 3 - Radially inwardly rib 3.1 - Axially oriented rib 3.2 — Circumferentially oriented rib 3.3 - Slit 4 — Spacer

Items The presently disclosed may be described in further detail with reference to the following items.

1. A vial adapter, comprising two chamber parts in axial extension of each other, wherein a first chamber part is configured for slidably receiving at least a part of a vial crown, and a second chamber part is configured for slidably receiving at least a part of a vial body, wherein the first chamber part andor the second 15 chamber part comprises one or more ribs extending radially inwardly of a chamber wall.

20 2. The vial adapter according to item 1, wherein the first chamber part comprises a coherent cylindrical chamber wall.

3. The vial adapter according to any of the preceding items, wherein the second chamber part comprises of a coherent cylindrical chamber wall.

4. The vial adapter according to item 3, wherein the second chamber part consists 25 of a coherent cylindrical chamber wall.

30

The vial adapter according to any of the preceding items, wherein the first chamber part is configured for slidably receiving at least 50% of the vial crown, such as at least 60, 70, 80, 90, or 100% of the vial crown.

6. The vial adapter according to any of the preceding items, wherein the first chamber part has a top chamber wall comprising one or more spacers, such as between 2-10 spacers, more preferably 3, 5 or 7 spacers.

35 7. The vial adapter according to item 6, wherein the distal end of the spacers have a spherical or semi spherical shape.

WO 2022112543 23 PCTEP2021083281 10 8. The vial adapter according to any of the preceding items, wherein the two chamber parts are cylindrical, and wherein the internal diameter of the first chamber part is smaller than the internal diameter of the second chamber part.

9. The vial adapter according to any of the preceding items, wherein the first chamber part has an internal diameter of between 10-50 mm, more preferably between 15-40 mm, and most preferably between 20-30 mm, such as 23 or 25 mm.

10. The vial adapter according to any of the preceding items, wherein the second chamber part has an internal diameter of between 10-50 mm, more preferably between 20-40 mm, and most preferably between 25-30 mm, such as 27 or 29 mm.

11. The vial adapter according to any of the preceding items, wherein the second chamber part is configured for slidably receiving at least 20% of the vial body, such as at least 25, 30, 40, 50, 60, 70, 80, 90, or 100% of the vial body.

20 12. The vial adapter according to any of the preceding items, wherein the one or more radially inwardly ribs are axially oriented.

25 13. The vial adapter according to item 12, wherein the axially oriented ribs are configured as vial crown retainers andor vial body retainers, such as wedges.

14. The vial adapter according to any of items 12-13, wherein the axially oriented ribs comprises a planar or annular shaped section, as seen in cross-sectional view, for engaging with the vial crown andor vial body.

30 15. The vial adapter according to item 14, wherein the axially oriented ribs have a cross sectional shape selected from the group of: isosceles trapezoidal, trilateral trapezoidal, rectangular, or squared.

16. The vial adapter according to any of items 12-15, wherein the axially oriented 35 ribs are configured to be elastic compressive outwardly towards the chamber wall.

WO 2022112543 24 PCTEP2021083281 17. The vial adapter according to any of items 12-16, comprising two or more axially oriented ribs, such as three, four, five, six, seven, eight, nine, or ten axially oriented ribs, and preferably four axially oriented ribs.

18. The vial adapter according to any of items 12-17, wherein the axially oriented ribs are arranged rotational symmetric within the cylindrical part.

19. The vial adapter according to any of items 12-18, wherein the axially oriented ribs are arranged at an equal interval along the circumferential direction of the 10 cylindrical part.

20. The vial adapter according to any of items 12-19, wherein the axially oriented ribs extend inwardly with a radial angle of 90 degrees.

21. The vial adapter according to any of items 12-19, wherein the axially oriented ribs extend inwardly with a radial angle of below 90 degrees, preferably an angle of below 80, 70, 60, 50, 40, or 30 degrees.

22. The vial adapter according to item 21, wherein the axially oriented ribs extend 20 inwardly with the same radial angle.

23. The vial adapter according to any of items 12-22, wherein the inwardly extension of the axially oriented ribs changes along the axial extension.

25 24. The vial adapter according to item 23, wherein the inwardly extension of the axially oriented ribs are smaller towards a distal end.

The vial adapter according to any of items 23-24, wherein the inwardly extension of the axially oriented ribs changes linearly along at least a part of the 30 axial extension.

26. The vial adapter according to any of items 12-25, wherein the axially oriented ribs comprises a curved line portion, as seen from an axial direction.

35 27. The vial adapter according to item 26, wherein the axially oriented ribs are shaped as impeller blades, as seen from an axial direction.

WO 2022112543 25 PCTEP2021083281 10 28. The vial adapter according to any of the preceding items, wherein the one or more radially inwardly ribs are circumferentially oriented ribs extending along at least a part of the circumference of the chamber wall.

29. The vial adapter according to item 28, wherein the at least one circumferentially oriented rib is configured as a vial crown retainer, andor a vial body retainer.

30. The vial adapter according to any of items 28-29, wherein the at least one circumferentially oriented rib is configured for snap fitting over the vial crown.

31. The vial adapter according to any of items 28-30, wherein the at least one circumferentially oriented rib is flexible.

32. The vial adapter according to any of items 28-31, comprising one or more 15 circumferentially oriented ribs, such as two, three, or four circumferentially oriented ribs.

33. The vial adapter according to any of items 28-32, wherein the at least one circumferentially oriented rib extend around below 50% of the circumference of 20 the first chamber wall, andor the second chamber wall, such as below 40%, 30%, 25%, 20%, 15%, 10% or 5%.

25 34. The vial adapter according to any of items 28-33, wherein the length of the circumferentially oriented rib(s) are below 2 cm, such as below 1.5 cm or 1 cm.

35. The vial adapter according to any of items 28-34, wherein the at least one circumferentially oriented rib extend inwardly with an angle of 90 degrees.

36. The vial adapter according to any of items 28-34, wherein the at least one 30 circumferentially oriented rib extend inwardly with an inclined angle towards the chamber part.

37. The vial adapter according to any of items 28-36, wherein the at least one circumferentially oriented rib has a rectangular or triangular shape, as seen in 35 cross-sectional view.

38. The vial adapter according to item 37, wherein the circumferentially oriented ribs have a triangular shape selected from the group of: equilateral triangular,

WO 2022112543 26 PCTEP2021083281 isosceles triangular, and scalene triangular, and preferably is scalene triangular with the shorter leg of the triangle facing the top chamber wall.

39. The vial adapter according to any of items 28-38, wherein the at least one circumferentially oriented rib is placed at the distal end of the first chamber part.

40. The vial adapter according to any of items 28-39, wherein the at least one circumferentially oriented rib is placed at a distance from the distal end of the first chamber part, such below 50%, 40%, or 30% of the first chamber length 10 from the distal end.

41. The vial adapter according to any of items 28-40, wherein the at least one circumferentially oriented rib is adjacent to at least one circumferentially oriented slit.

42. The vial adapter according to item 41, wherein the at least one circumferentially oriented slit is connected to at least one partially axially oriented slit.

43. The vial adapter according to item 42, wherein the at least one circumferentially 20 oriented slit is connected to two or more axially oriented slits.

44. The vial adapter according to item 43, wherein the two or more axially oriented slits extend towards a proximal end andor a distal end.

25 45. The vial adapter according to any of items 42-44, wherein the length of the circumferentially oriented slit is similar or smaller than the length axially oriented slit, such as at least 70%, 60%, 50%, 40%, or 30% smaller.

46. The vial adapter according to any of items 42-45, wherein the circumferentially 30 oriented slit is located within the first chamber part, and the axially oriented slit(s) are located within the first chamber part andor the second chamber part.

47. The vial adapter according to any of the preceding items, wherein the piercing member comprises a cylindrical section and a conic shaped tip section.

48. The vial adapter according to any of the preceding items, wherein the piercing member comprises multiple openings, more preferably between 2-8 openings, such as 3, 4, or 5 openings.

WO 2022112543 27 PCTEP2021083281 49. The vial adapter according to item 48, wherein the openings are shaped as linear slits disposed along at least a part of the cylindrical section and the conic section of the piercing member.

50. The vial adapter according to any of items 47-49, wherein the distal tip of the piercing member is located between located between 25-50% from the top wall relative to the chamber lengths, more preferably between 30-45%, such as 35, 37, 40, or 44%.

51. The vial adapter according to any of items 47-50, wherein the circumferentially oriented slits are located at essentially the same distance from the top wall relative to the chamber lengths, as the distal tip of the piecing member.

52. The vial adapter according to any of items 28-51, wherein the circumferentially oriented ribs are located between 15-30% from the top wall relative to the chamber lengths, more preferably between 20-30%, such as at least 23%.

References

1. A vial adapter, comprising two chamber parts in axial extension of each other, wherein a first chamber part is configured for slidably receiving at least a part of a vial crown, and a second chamber part is configured for slidably receiving at least a part of a vial body, wherein the first chamber part and/or the second chamber part comprises one or more ribs extending radially inwardly of a chamber wall.

2. The vial adapter according to claim 1, wherein the second chamber part comprises or consists of a coherent cylindrical chamber wall.

3. The vial adapter according to claim 1, wherein the one or more radially inwardly extending ribs are axially oriented.

4. The vial adapter according to claim 3, wherein the axially oriented ribs are configured as vial crown retainers and/or vial body retainers.

5. The vial adapter according to claim 3, wherein the axially oriented ribs are configured to be elastic compressive outwardly towards the chamber wall.

6. The vial adapter according to claim 3, wherein the axially oriented ribs comprises a planar or annular shaped section, as seen in cross- sectional view, for engaging with the vial crown and/or vial body.

7. The vial adapter according to claim 6, wherein the axially oriented ribs have a cross sectional shape selected from the group of: isosceles trapezoidal, trilateral trapezoidal, rectangular, or squared.

8. The vial adapter according to claim 3, wherein the axially oriented ribs extend inwardly with a radial angle of below 90 degrees, or an angle of below 80, 70, 60, 50, 40, or 30 degrees.

9. The vial adapter according to claim 1, wherein the one or more radially inwardly extending ribs are circumferentially oriented ribs extending along at least a part of the circumference of the chamber wall.

10. The vial adapter according to claim 9, wherein the at least one circumferentially oriented rib is configured for snap fitting over the vial crown.

11. The vial adapter according to claim 9, wherein the at least one circumferentially oriented rib is placed at the distal end of the first chamber part.

12. The vial adapter according to claim 9, wherein the at least one circumferentially oriented rib is adjacent to at least one circumferentially oriented slit.

13. The vial adapter according to claim 12, wherein the at least one circumferentially oriented slit is connected to at least one partially axially oriented slit, optionally wherein the at least one circumferentially oriented slit is connected to two or more axially oriented slits.

14. The vial adapter according to claim 1, wherein the vial adapter comprises a piercing member for piercing or puncturing a septum of a cap of the received vial crown.

15. (canceled)

16. The vial adapter according to claim 1, wherein the vial adapter comprises a top wall located near a proximal end of the adapter and opposite to a chamber opening for receiving at least the part of the vial crown, wherein the chamber opening is located at a distal end of the adapter, and wherein a length between the top wall and the chamber opening defines a chamber length.

17. The vial adapter according to claim 14, wherein the vial adapter comprises a top wall located near a proximal end of the adapter and opposite to a chamber opening for receiving at least the part of the vial crown, wherein the chamber opening is located at a distal end of the adapter, and wherein a length between the top wall and the chamber opening defines a chamber length, and wherein a distal tip of the piercing member is located between 25-50% from the top wall relative to the chamber length, or between 30-45% from the top wall relative to the chamber length.

18. The vial adapter according to claim 4, wherein the axially oriented ribs are configured as wedges.

19. The vial adapter according to claim 9, wherein the vial adapter comprises a top wall located near a proximal end of the adapter and opposite to a chamber opening for receiving at least the part of the vial crown, wherein the chamber opening is located at a distal end of the adapter, and wherein a length between the top wall and the chamber opening defines a chamber length, and wherein the circumferentially oriented ribs are located between 15-30% from the top wall relative to the chamber length.

20. The vial adapter according to claim 14, wherein the piercing member comprises a cylindrical section and a conic shaped tip section.
